(19) United States
(12) Patent Application Publication
(10) Pub. No.: US 2004/0064917 A1
(43) Pub. Date: Apr. 8, 2004

(54) Electromechanical hinged wing drive

(76) Inventor: Jurgen Homberg, Hagen (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/467,759

(22) PCT Filed: Feb. 11, 2002
(86) PCT No.: PCT/EP02/01389

(30) Foreign Application Priority Data
Feb. 13, 2001 (DE) 101 07 051.9

(51) Int. Cl. E05F 15/12; E05F 3/10

(52) U.S. Cl. 16/62

(57) ABSTRACT

The invention relates to an electromechanical swing leaf operator having a door closer (1) with an eccentrically supported pinion (6) that presents a circular rolling curve and meshes with a toothed rack (5) being disposed at a piston (4), whereby a particular execution of the rolling curve and of the teeth (9) of the toothed rack (5) in adaptation to a toothing of the pinion (6) is achieved. With the intention to realize an optimized moving course of the piston (4) in the housing (2) of the door closer (1) an improved execution of the delayed closing operation is provided.

DE 41 24 282 02 describes an electromechanical swing door operator, in which an electrical motor—if necessary with an in-line integrated clutch drives a gear, which is directly, or with an in-line integrated gear train, connected with a closing shaft of a door closer. In this case, the door closer can be executed as overhead door closer with a slide arm assembly. As the electrical motor acts, via a gear train or several gear trains, directly on the closing shaft of the door closer, additional pulse encoders, clock members, detectors and limit switches controlling the electrical motor are required for the realization of the required opening- and closing characteristics.

Furthermore manually operable overhead door closers with slide arm assembly are known in which a piston, being guided in a housing and leaning against a closing spring, is provided, wherein a toothed pinion arranged at the closing shaft meshes with a toothed rack of the piston.

Above mentioned overhead door closers with slide arm assembly, also known as rack and pinion door closers, with regard to traditional door closers, advantageously do not present an arm assembly protruding uncovered into the room, but they simply present an actuation arm sitting close and flat at the door frame or at the door leaf and cooperating with a sliding member that is slidably located in a slide rail. They do, however, bear the disadvantage that the actuation arm, sitting close and flat at the door frame or at the door leaf, leads to an unfavourable course of forces at the door, in relation with conventional, symmetric rack and pinion mechanics. It is therefore an object to conceive an optimal rack and pinion drive, with the intention to achieve, during the opening procedure and closing procedure of the door, a progression of the pinion, as low in friction and smooth as possible, at the associated toothed rack and therefore of the piston inside the piston housing, which circumstance simultaneously corresponds to an ideal course of the momentum.

Centrically or eccentrically supported pinions are used in known door closers.

A door closer having an eccentrically supported pinion is known from EP 0 856 628 A1, wherein the toothing of the toothed rack forms a linearly extending pitch line of engagement having an angle comprised between 4.5° and 7.2° with regard to the moving direction of the piston. The selection of an angle depends on the size of the door closer, respectively on the strength of the closing spring. Because of the eccentric support of the pinion and of the linear course of the toothed rack, an optimal, especially low friction and smooth progression of the pinion's teeth at the toothed rack is not guaranteed; there are spreads in the course of the momentums' curves.

A comparable solution applying a linearly extending toothed rack with an angle is described in U.S. Pat. No. 633,682.

Furthermore DE 36 45 313 C2 and DE 36 45 314 C2 reveal an eccentrically supported pinion where a rolling curve, arranged at the pinion, is used, having various lever arms in relation to the rotary axis. Accordingly, the rolling curve of the associated toothed rack extends in an arcuate form.

In a door closer known from DE 82 17 72 02 respectively from the French Patent Application 96 69 45, the closer shaft is connected at an eccentrically supported elliptical toothed wheel meshing with an inclined toothed rack on the piston side. Up to a certain degree, a transmission, adapted to a desired course of the momentum, is achieved by means of the elliptical gear due to the differently long lever arms of the elliptical toothed wheel.

The pneumatic door closer according to U.S. Pat. No. 1,359,144 presents a circular eccentrically supported pinion which meshes with an uneven toothed rack at the piston. The circular pinion is provided with a regular toothing on a circular rolling curve, whereby varying lever arms come into effect due to the eccentrical support.

Various piston drive embodiments in door closers are described in DE 36 38 353 A1 in EP 0 207 251 A2, in DE 94 12 64 and in U.S. Pat. No. 2,933,755, whereby in relation with eccentrically or centrically supported pinions—if necessary with in-line arrangement of a transmitting gear drive—a direct charge of the closing spring is exerted by means of a crank drive.

Centrically supported pinions are known from EP 0 056 256 A2 as well as from EP 0 350 568 A2. EP 0 056 256 A2 deals with a door closer, the pistons thereof presenting two symmetrically, diametrically opposite toothed racks, whereby a centrically supported pinion engages, in the closing position, with shortened teeth, in both toothed racks of the piston.

The door closer according to EP 0 350 568 A2 presents a centrically supported pinion, which presents teeth extending at the circumference, with progressively increasing depths of teeth, which teeth engage between the rods of a correspondingly curve-shaped extending toothed rack.

A substantially centrically supported pinion of a drive for a door or for a window is disclosed in DE 44 44 131 A1 and DE 44 44 133 A1, wherein the pinion itself presents a toothing over up to approximately half the circumference thereof, the teeth thereof being disposed at lever arms varying in length and progressing on a correspondingly curved rolling curve of a toothed rack.

The object of the invention is, when using an electromechanical drive for the opening procedure of the connected door, whereby the closing procedure should not be performed by the electromechanical drive, but by a power storage (power transmission unit), to provide a small and inexpensive swing leaf operator that guarantees the same required opening and closing characteristics as an overhead door closer with slide arm assembly does, i.e. to optimize the course of movements of the piston of the door closer during the opening and the closing procedures within the door closer housing, i.e. to guarantee especially a jam-free and therefore low friction progression of the pinion at the toothed rack of the piston. By using a pinion having an appropriate rolling curve, the pinion's cost of production should be minimized, whereby, compared to known toothed racks, a particular embodiment of the toothed rack, due to the intended low friction to be achieved, should result in a longer lasting working life and in higher efficiency, which in return allows for using a weaker closing spring. In execution of the invention an improvement of the closing characteristics of the overhead door closer with slide arm assembly should be achieved additionally through an improved oil exchange from the piston chamber to the spring chamber during the closing procedure.

The invention solves the given problem with the teaching according to the claims 1 to 3.

According to the invention it is used either an arrangement comprising substantially individual modules: a door closer, a gear and a motor or comprising an entity, which includes in a housing: a motor, a gear and a power transmission unit, whereby the power transmission unit includes the functions of a door closer. In this case, at the power transmission unit or at the door closer, a toothed rack respectively the teeth thereof are adapted in an optimum way to the course of a toothing of a pinion while respecting the eccentrical support thereof and the circular rolling curve thereof, such that a smooth transition to each following adjacent tooth is guaranteed, during the opening procedure as well as during the closing procedure. This applies particularly to the portion of the pinion exceeding the rotation of 1800.

When a separate door closer is used, it will present a two-sided axle exit, whereby one axle exit is used for the connection of a lever, which via a sliding member cooperates with a sliding rail, and the opposite axle exit with a power transmission member is connected, in an already known manner, with the gear of a corresponding motor.

In this case, the gear may be flanged directly or indirectly to the door closer. Furthermore it is conceivable to utilize here a corresponding mounting plate, which allows for separately placing the individual modules, such as door closer gear and motor, in order to guarantee flexible exchange in case of a defect of individual modules.

Furthermore it is likewise possible to accommodate the above described individual modules, such as the door closer, the gear and the motor, in an aggregate bloc, whereby in this case the internal structure of the door closer and the one of the power transmission unit are the same or may appear as acting the same. In this case, it has proven to be advantageous that the opening-sided teeth's flank angle of the toothed rack be executed substantially in ascending manner up to approximately half the length of the toothed rack, and subsequently they be executed substantially in a constant or descending manner, whereby the descending course contributes to improving the low friction.

The decreasing course contributes in this case to improve the reduction in friction.

The rotation of the pinion, from the closing position up to the maximum opening position, may comprise more or less than approximately 180°, without having any negative influence on the required effectiveness. It is essential in this case that the closing-sided tooth profiles of the last teeth of the toothed rack in the opening direction, arranged in the portion adjoining the 180°, be executed with an angle or rounded.

In execution of the invention basically optional tooth forms may be used; i.e. the pinion and/or the toothed rack may present teeth with straight, angled or convex curved tooth profiles. However, it has proven to be advantageous—especially for reasons regarding production techniques—to attribute substantially a spur toothing to the toothed rack and an involute toothing to the pinion.

With the intention to achieve optimized closing characteristics, the invention includes furthermore an improvement of the oil exchange between the piston chambers separated by the piston.

Depending on the application field of the swing leaf operator, different closing phases may be associated to the closing procedure of the connected door. These may include for example two or four closing phases with different speeds at the door leaves. For example four closing phases have shown the most comfort.

Accordingly, the closing procedure comprises four closing phases, each closing phase, while including a certain tolerance, being associated in an already known manner to one closing angle. The first closing phase, as well as the third one, may be controlled through a single valve by means of the longitudinal groove that is arranged in the skirt of the piston such that the attainable low friction course of the pinion at the toothed rack is assisted by an advantageous embodiment of the oil exchange from the piston chamber to the spring chamber during the closing procedure, whereby a commonly required valve for the third closing phase is abandoned.

A swing leaf operator of this type is considered as opening support, whereby, however, the closing procedure of the door is realized, for example, by the above described door closer. A door closer, equipped with a cam disc, may be likewise used, the drive motor, however, requires considerably higher performance, which would forcibly lead to increasing the price and to increasing the dimension of the swing leaf operator.

The invention will be explained in detail on the basis of a diagrammatically represented possible embodiment example, in which

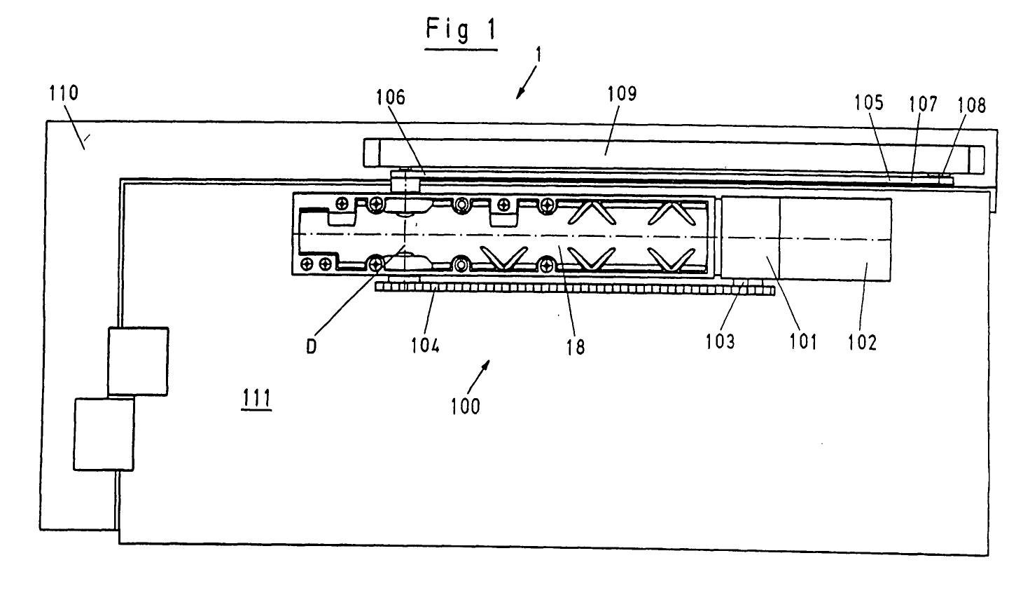

FIG. 1 shows a diagrammatical front view of an electromechanical swing leaf operator.

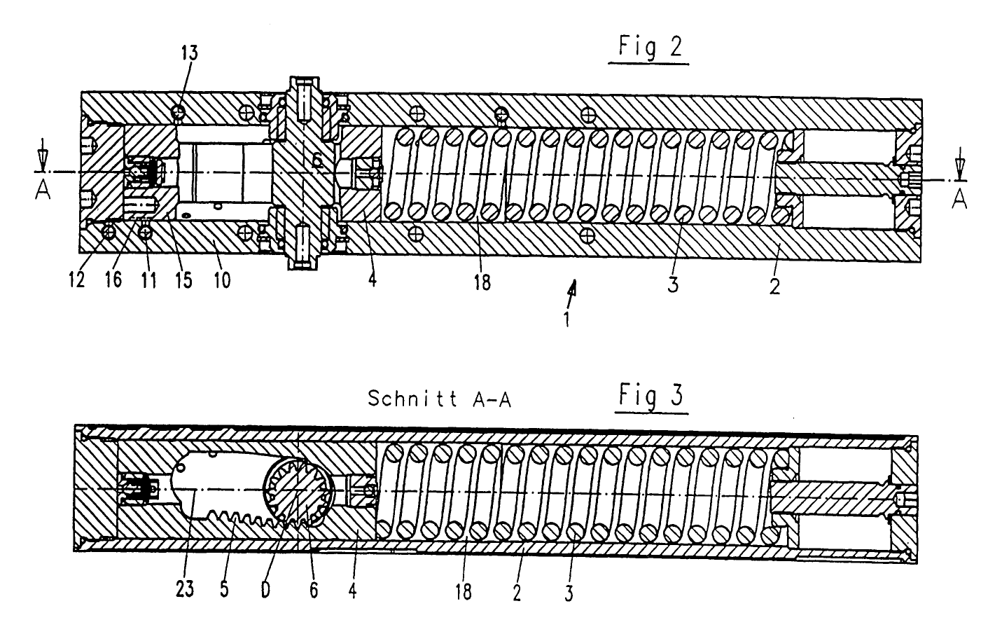

FIG. 2 shows a vertical section through a closer housing.

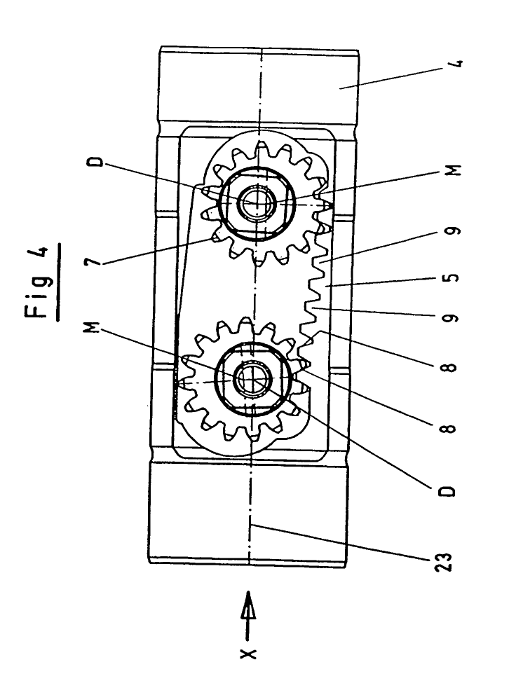

FIG. 3 shows a section according to line A-A according to FIG. 1.

FIG. 4 shows a plane view on the piston including two final positions of the pinion.

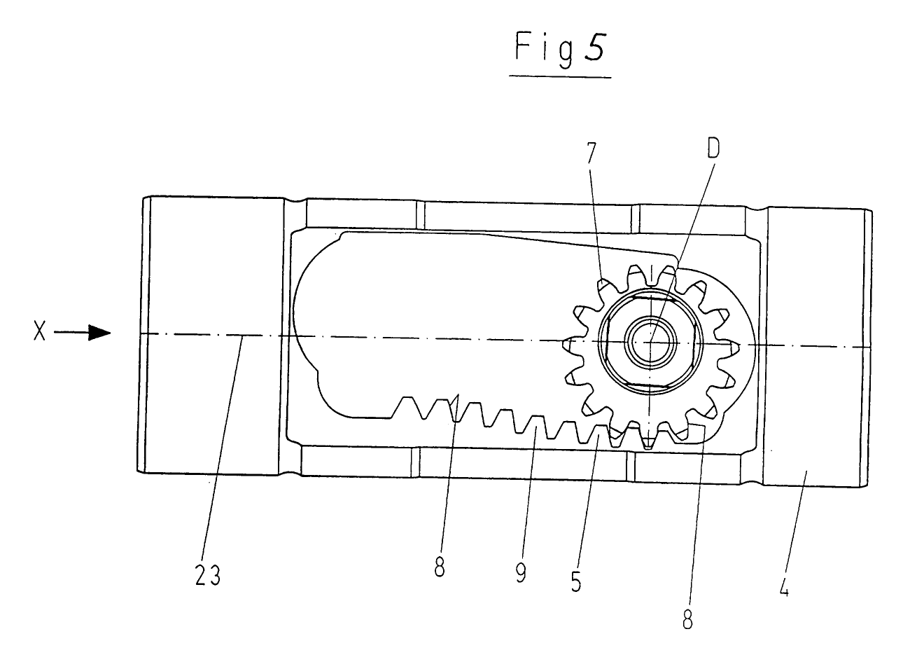

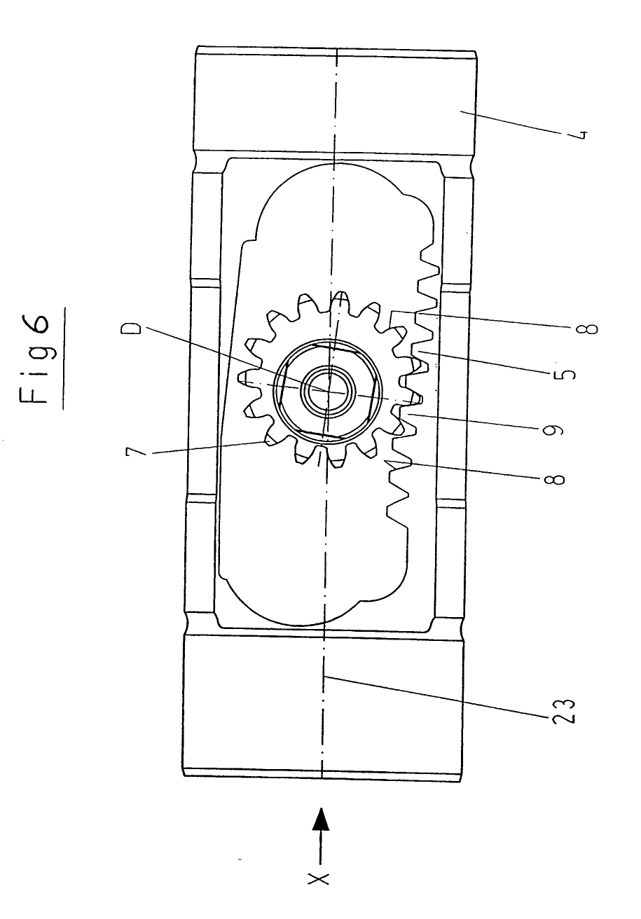

FIGS. 5 to 7 show three phases of the course of the pinion at a toothed rack

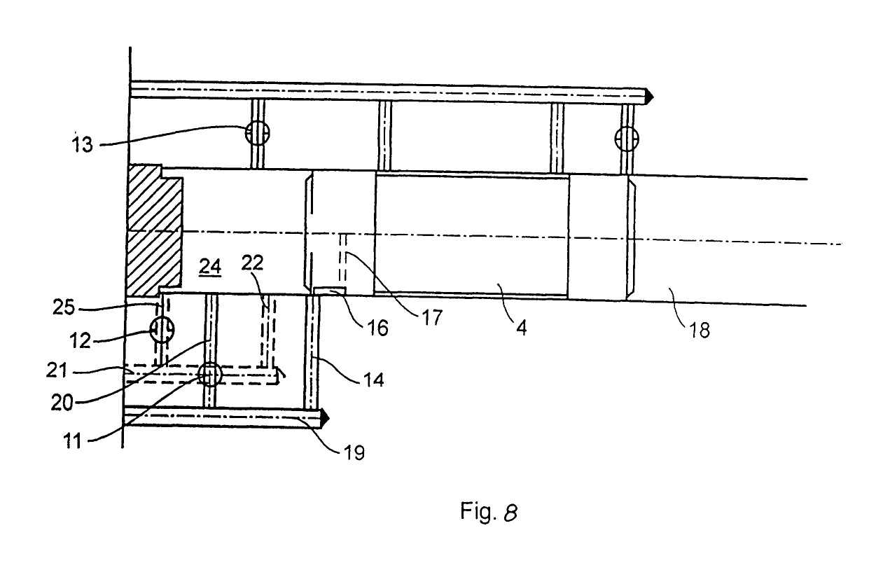

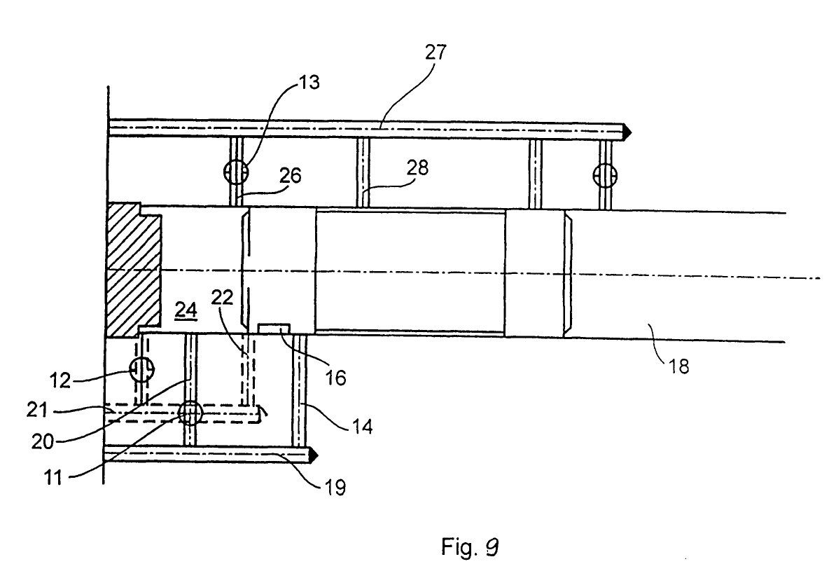

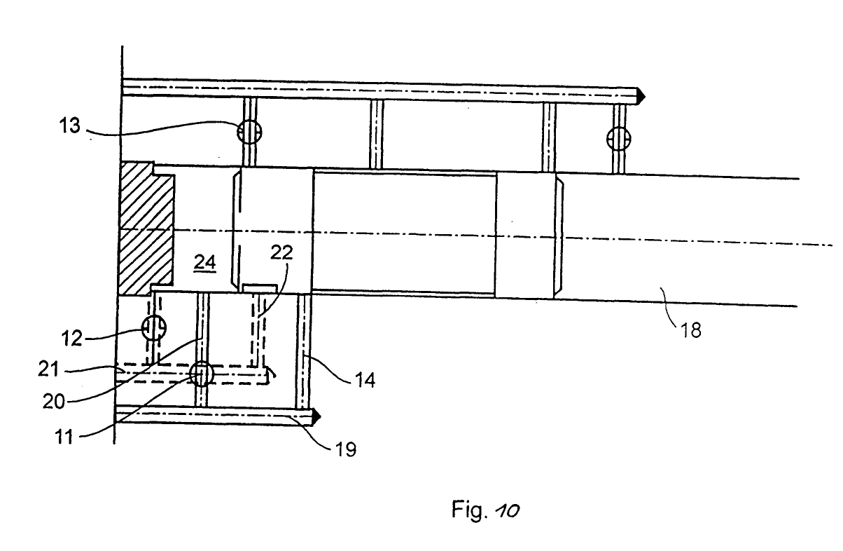

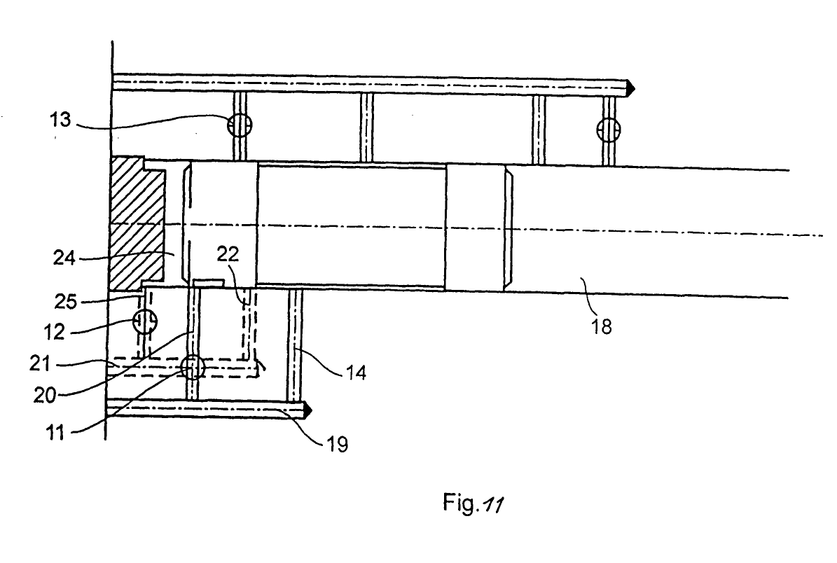

FIGS. 8 to 11 show, in a diagrammatic illustration, four positions of the piston during the delayed closing operation.

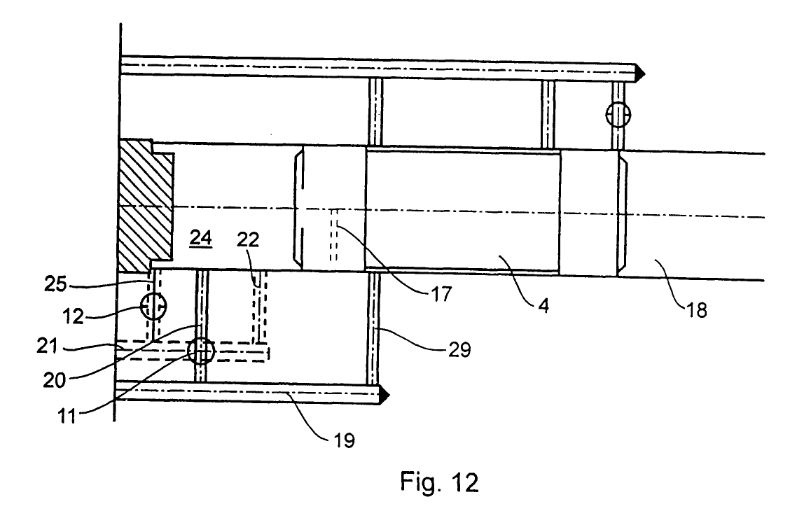

FIG. 12 shows a second possibility of the delayed closing operation.

FIG. 1 shows the diagrammatical illustration of an electromechanical swing leaf operator 100, whereby, in the illustrated embodiment example, a drive means is disposed at the door leaf 111 and a sliding rail 109 is disposed at a door frame 110. The drive presents an electric motor 102 acting upon a gear 101. A gear exit shaft 103 is connected with a rotary axis D of a pinion 6, not illustrated in FIG. 1, (see FIG. 4), via gear traction 104 executed as a chain, a cable or a toothed belt. According to the FIGS. 2 to 4, the pinion 6 is guided in a piston 4, likewise not illustrated in FIG. 1, which is loaded through a closing spring 3 disposed in a spring chamber 18. At the rotary axis D of the pinion 6, a free end 106 of an arm 105 acts rotary-solid, its other free end 107 is guided, by means of a sliding member 108, in the sliding rail 109. It is to be understood that, if the dimensional ratios are appropriate, the sliding rail 109 can be located at the door leaf 111 and the drive can be located at the door frame 110. According to FIGS. 2 to 7, a closing spring 3 acts on a piston 4 which is guided in a housing 2 of a door closer. As illustrated in FIGS. 3 and 4, the piston 4 has a toothed rack 5 meshing with the pinion 6, which presents an involute toothing 7. In the region of the center longitudinal axis referenced to with numeral 23, the pinion 6 is eccentrically supported on the rotary axis referenced to with D, whereby in the closing position of pinion 6, illustrated in FIG. 4, a central point M of the rolling circle of pinion 6 is offset into the direction towards the toothed rack 5, and in the opening position, illustrated in FIG. 3, the central point M of the rolling circle of pinion 6 is offset into the opposite direction. The rolling curve of pinion 6, as can be seen, is circular. The teeth of toothed rack 5, generally referenced to with numeral 9, present opening-sided tooth profiles and closing-sided tooth profiles, wherein the closing-sided tooth profiles 8 (see FIG. 3) of the last two teeth 9 are executed with an angle. The tooth profiles of all the other teeth 9 present a straight course. The afore-mentioned measure guarantees that during a movement of piston 4 in the direction of arrow X (opening direction) when the pinion 6 progresses on the toothed rack 5, even in the region, in which the pinion 6 has slightly exceeded the rotation about 180°, a low friction mating of the involute toothing 7 with the teeth 9 of toothed rack 5 is realized. By the way, the rolling curve of the toothed rack 5 is adapted to the eccentrical support of pinion 6 and presents a correspondingly slightly S-shaped course, wherein all teeth 9 of the toothed rack 5 present different flank angles on the opening-side and on the closing-side.

Respectively separated positions of pinion 6 are illustrated in the FIGS. 4 to 6. In this case, FIG. 4 illustrates the closing position, i.e. when the door is closed, namely the position of the piston 4 and of the pinion 6. In this case, the pinion 6 is located in the right zone of the aperture of piston 4. In this case, the rotary axis D is located on the center longitudinal axis 23. If the piston 4 is moved into the opening direction (direction of arrow X), the pinion 6 will rotate about the rotary axis D. Due to the eccentricity of pinion 6, a position arranged almost in a central region can be seen in FIG. 5, position that corresponds to a certain opening position of the door. Through the progression of pinion 6 at the toothed rack 5, the piston 4 has moved further into the opening direction.

A final position of the pinion 6, corresponding to the maximum opening side of the door, which is not illustrated, is represented in FIG. 6. These three FIGS. 4 to 6 clearly show the course of the eccentrically supported pinion with an involute toothing, wherein simultaneously likewise the constant mating of the teeth 7 of pinion 6 with the toothed rack 5 with its teeth 9 can be appreciated.

As especially shown in FIG. 2 and in FIGS. 8 to 11, three control valves 11, 12, and 13, serving the delayed closing operation, are disposed in the housing walls 10 of the door closer 1, and the functions thereof will be explained hereinafter on the basis of FIGS. 8 to 11.

It is pointed out, for the reason of completeness that instead of the door closer I another device may be used, for example a power transmission unit having the same or the same operating inner structure as a door closer or an overhead door closer with slide arm assembly.

During the start of the closing procedure according to FIG. 8, the piston 4 passes an oil outlet duct 14, which, via a duct 19, is connected with a control valve 11 and via a duct 20 with a piston chamber 24. The oil exiting the piston chamber 24, via a longitudinal groove 16 in the skirt of the piston 15 and a radial borehole 17 in the piston 4, can pass over into the spring chamber 18. The ducts 25, 21, and 22, associated to the control valve 12 are arranged in another plane.

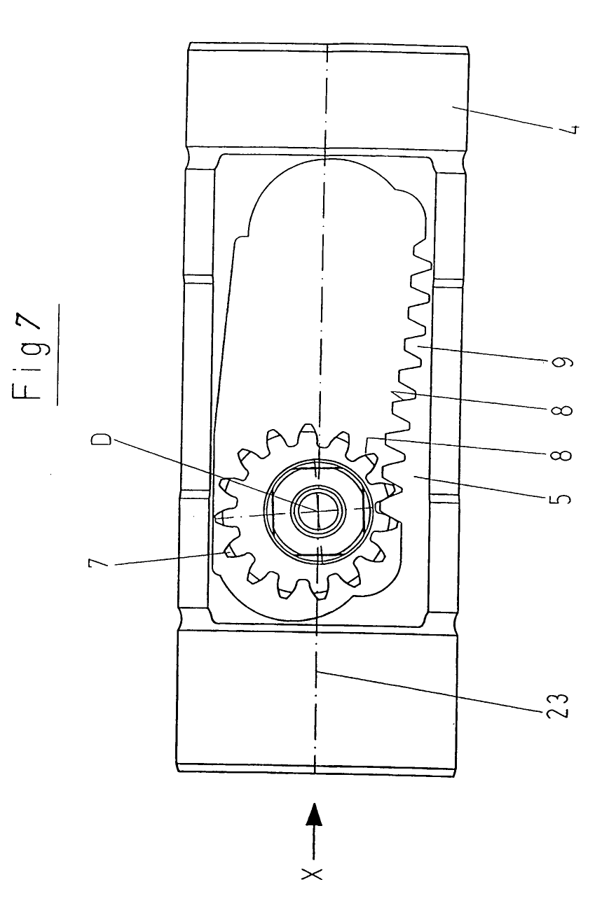

According to FIG. 7, the longitudinal groove 16 has passed the duct 14, such that an oil transfer, from the piston chamber 24 to the spring chamber 18, is only possible due to the play between the piston 5 and the housing wall 10, resulting in a strong delay of the closing speed (second phase of the delayed closing operation).

During the third phase of the delayed closing operation, the oil passes again from the piston chamber 24, via the duct 20 and the same control valve 11 as well as the ducts 19 and 14 into the region of a not specifically illustrated overflow edge of piston 4, into the spring chamber 18. As the same control valve 11 is involved, the closing speed is identical in the first and in the third delaying phase.

During the fourth phase of the delayed closing operation (beginning of the closing region) the duct 20 of the valve 11 leading to the piston chamber 24 is closed; in this case the oil coming from the piston chamber 24 passes, via the duct 25, the control valve 12, the duct 21, and the duct 22 via the afore mentioned overflow edge, into the spring chamber 18. The control valve, referenced to with the numeral 13, is normally closed during the delayed closing operation; there is, however, the possibility of reducing the delaying period, through corresponding opening of this valve during the second closing phase (during which an oil exchange happens only through leakage between the piston and the housing walls), whereby the oil exiting the piston chamber 24 is conducted, while being reduced, via the duct 26, the control valve 13, the duct 27, and the duct 28, into the spring chamber 18.

An alternative embodiment with regard to the execution of the oil outlet ducts and the valves for controlling the closing procedure is illustrated in FIG. 12. In this alternative embodiment only two different closing phases are realized, such that a modification with regard to the above described four closing phases is possible. Therefore, only the valves 11 and 12 are required. The oil outlet duct 19 is extended and leads into an oil outlet duct 29 ending behind the not specifically designated overflow edge of piston 4 in the region of the toothed rack 5.

Besides the above described two embodiment examples with regard to different closing phases of the connected doors, it is of course possible, within the scope of the invention, to realize a different number of closing phases having various closing speeds.

### References

1 door closer

2 housing

3 closing spring

4 piston

5 toothed rack

6 pinion

7 involute

8 closing-sided tooth profiles

9 teeth of the toothed rack

10 housing walls

11 control valve

12 control valve

13 control valve

14 oil outlet duct

15 skirt of the piston

16 longitudinal groove

17 radial bore hole

18 spring chamber

19 oil outlet duct

20 oil outlet duct

21 oil outlet duct

22 oil outlet duct

23 center longitudinal axis

24 piston chamber

25 oil outlet duct

26 oil outlet duct

27 oil outlet duct

28 oil outlet duct

29 oil outlet duct

100 swing leaf operator

101 gear

102 electrical motor

103 gear exit shaft

104 gear train

105 arm

106 free end

107 free end

108 sliding member

109 slide rail

110 door frame

111 door leaf

M central point of the working circle of the pinion

D rotary axis of the pinion

x direction of the arrow in the opening direction

1. Electromechanical swing leaf operator (100) having a pinion (6) that is driven by an electrical motor (102) via a gear (101), is eccentrically and rotatably supported at a housing (2) of a door closer (1) or at an appropriate power transmission unit, presents a circular rolling curve, and meshes with a toothed rack (5) of a piston (4) being guided in a housing (2) and leaning against a closing spring (3), whereby a central point (M) of the rolling curve is offset, in relation to a rotary axis (D) of the pinion (6) in the closing position, into the direction towards the toothed rack (5), and in relation to the rotary axis (D) in the opening position, into the opposite direction, characterized by the following characteristics:
the pinion (6) presents a toothing (7);
the toothed rack (5) is executed as toothed rack profile section and the closing-sided tooth profiles (8) of the last teeth (9) in the opening direction (arrow X) are executed with an angle,
the teeth (9) of the toothed rack (5) are located on an S-shaped rolling curve, whereby respectively starting from the closing position, the rolling curve is executed substantially in an ascending manner up to approximately half the length of the toothed rack (5) and subsequently in a descending manner,
all teeth (9) of the toothed rack (5) present different profile angles on the opening side and on the closing side,
the opening-sided flank angle of the teeth (9) substantially ascends up to approximately half the length of the toothed rack (5) and subsequently extends substantially in a constant manner,
the closing-sided flank angle of the teeth (9) substantially descends up to approximately half the length of the toothed rack (5) and subsequently extends in an ascending manner,
the width of the tooth head of the teeth (9) substantially ascends up to approximately half the length of the toothed rack (5) and subsequently extends in a descending manner,
the rotation of the pinion (6) from the closing position into the maximum opening position sums up to more than 1800, whereby the closing-sided tooth profiles (8) of the last teeth (9) of the toothed rack (5) in the opening direction (arrow X), which profiles are associated to the portion of the pinion (6) exceeding the 1800, are executed with an angle,
and the piston (4) is guided within the housing (2) by means of at least one control valve (11, 12, 13) in a way delaying the closing operation.

2. Electromechanical swing leaf operator (100) having a pinion (6) that is driven by an electrical motor (102) via a gear (101), is eccentrically and rotatably supported at a housing (2) of a door closer (1) or at an appropriate power transmission unit, presents a circular rolling curve, and meshes with a toothed rack of a piston (4) being guided in a housing (2) and leaning against a closing spring (3), whereby a central point (M) of the rolling curve is offset, in relation to the rotary axis (D) of the pinion (6) in the closing position, into the direction towards the toothed rack (5), and in relation to the rotary axis (D) in the opening position, into the opposite direction, characterized by the following characteristics:
the pinion (6) presents a toothing (7);
the toothed rack (5) is executed as toothed rack profile section and the closing-sided tooth profiles (8) of the last teeth (9) in the opening direction (arrow X) are executed with an angle,
the teeth (9) of the toothed rack (5) are located on an S-shaped rolling curve,
whereby respectively starting from the closing position, the rolling curve is executed substantially in an ascending manner up to half the length of the toothed rack (5) and subsequently in a descending manner
all teeth (9) of the toothed rack (5) present different profile angles on the opening side and on the closing side,
the opening-sided flank angle of the teeth (9) substantially ascends up to approximately half the length of the toothed rack (5) and subsequently extends in a descending manner,
the closing-sided flank angle of the teeth (9) substantially descends up to approximately half the length of the toothed rack (5) and subsequently extends in an ascending manner,
the width of the tooth head of the teeth (9) substantially ascends up to approximately half the length of the toothed rack (5) and subsequently extends in a descending manner,
the rotation of the pinion (6) from the closing position into the maximum opening position sums up to more than 1800, whereby the closing-sided tooth profiles (8) of the last teeth (9) in the opening direction (arrow X), which profiles are associated to the portion of the pinion (6) exceeding the 1800, are executed with an angle and the piston (4) is guided within the housing (2) by means of at least one control valve (11, 12, 13) in a way to delay the closing operation.

3. Electromechanical swing leaf operator (100) having a pinion (6) that is driven by an electrical motor (102) via a gear (101), is eccentrically and rotatably supported at a housing (2) of a door closer (1) or at an appropriate power transmission unit, presents a circular rolling curve, and meshes with a toothed rack of a piston (4) being guided in a housing (2) and leaning against a closing spring (3), whereby a central point (M) of the rolling curve is offset, in relation to the rotary axis (D) of the pinion (6) in the closing position, into the direction towards the toothed rack (5), and in relation to the rotary axis (D) in the opening position, into the opposite direction, characterized by the following characteristics:
the toothed rack (5) is executed as toothed rack profile, whereby its closing-sided tooth profiles (8) of the last teeth (9) in the opening direction (arrow X) are executed with an angle or convex curved,
the teeth (9) of the toothed rack (5) are located on an S-shaped rolling curve, whereby respectively starting from the closing position:
the rolling curve is executed substantially in an ascending manner up to approximately half the length of the toothed rack (5) and subsequently in a descending manner,
all teeth (9) of the toothed rack (5) present different profile angles on the opening side and on the closing side,
the opening-sided flank angle of the teeth (9) substantially ascends up to approximately half the length of the toothed rack (5) and subsequently extends substantially in a constant manner, the closing-sided flank angle of the teeth (9) substantially descends up to approximately half the length of the toothed rack (5) and subsequently extends in an ascending manner,
the rotation of the pinion (6) from the closing position to the maximum opening position sums up to less than approximately 180°, whereby the closing-sided tooth profiles (8) of the last teeth (9) of the toothed rack (5) in the opening direction (arrow X), which profiles are associated to the portion of the pinion (6) approaching 1800, are executed with an angle,
and the piston (4) is guided within the housing (2) by means of at least one control valve (11, 12, 13) in a way to delay the closing operation.

4. Swing leaf operator according to one of the claims 1 to 3, characterized in that the pinion (6) and/or the toothed rack (5) present teeth having straight, angled or convex curved tooth profiles.

5. Swing leaf operator according to one of the claims 1 to 4, characterized in that the pinion (6) presents an involute toothing (7).

6. Swing leaf operator according to the claims 1 to 3, characterized in that, through various dispositions of the oil outlet ducts (19, 20, 21, 22, 25, 26, 27, 28, 29) and the control valves (II, 12, 13), different closing characteristics can be realized.

7. Swing leaf operator according to the claims 1 to 3, characterized in that the control valves (11, 12, 13) are located in a housing wall (10) of the housing (2), whereby two closing phases are assigned to at least one of the control valves (11, 12, 13).

8. Swing leaf operator according to the claims 1 to 7, characterized in that the closing procedure includes four phases of the delayed closing operation, whereby using the control valves (11, 12) the first control valve (11) controls a first closing phase comprised between approximately 180° and 100° as well as a third closing phase comprised between approximately 70° and 20° at the same closing speed, whereas the second control valve (12) controls the fourth closing phase comprised between approximately 20° and 0° and during the second closing phase comprised between approximately 100° and 70° the functioning of both control valves (11. 12. 13) is cancelled.

9. Swing leaf operator according to one or several of the preceding claims, characterized in that the oil outlet duct (14) of the first control valve (11) in the first phase of the delayed closing operation leads into a longitudinal groove (16) arranged in a skirt of the piston (15), which groove communicates with the spring chamber (18) via a spring-chamber-sided radial bore hole (17) of the piston (4) delimiting the longitudinal groove (16).

10. Swing leaf operator according to one or several of the preceding claims, characterized in that the oil outlet duct (14) leads into an oil outlet duct (19), which via the control valve (11), communicates with the oil outlet duct (20) that leads into a piston chamber (24).

11. Swing leaf operator according to one or several of the preceding claims, characterized in that in the second phase of the delayed closing operation, a pressure compensation of the piston chamber (24) to the spring chamber (18) is possible due to a play between the piston (5) and the housing wall (10).

12. Swing leaf operator according to one or several of the preceding claims, characterized in that, in the third closing phase, the oil from the piston chamber (24) passes, via the oil outlet duct (20) the control valve (11), and the oil outlet ducts (14, 19), and an overflow edge of the piston (5), into the spring chamber (18).

13. Swing leaf operator according to one or several of the preceding claims, characterized in that, in a fourth phase of the closing procedure the oil outlet duct (20) is closed, and the oil from the piston chamber (24) passes via the oil outlet duct (25), the control valve (12), and the oil outlet ducts (21 and 22) and via the overflow edge into the spring chamber (18).
